(19) United States
(12) Patent Application Publication
(10) Pub. No.: US 2026/0263194 A1
(43) Pub. Date: Sep. 10, 2026

(54) INTRAORAL SCANNER SYSTEM AND METHOD FOR SUPERIMPOSING A 2D IMAGE ON A 3D MODEL

(71) Applicant: 3SHAPE A/S, Copenhagen K (DK)

(72) Inventors: Mike VAN DER POEL, Copenhagen K (DK); Admir HUSEINI, Copenhagen K (DK); Christoph VANNAHME, Copenhagen K (DK); Asger STOUSTRUP, Copenhagen K (DK); Daniella ALALOUF, Copenhagen K (DK)

(73) Assignee: 3SHAPE A/S, Copenhagen K (DK)

(21) Appl. No.: 19/167,227

(22) PCT Filed: Mar. 21, 2024
(86) PCT No.: PCT/EP2024/057660

§ 371 Date: Sep. 19, 2025

(30) Foreign Application Priority Data
Mar. 22, 2023 (DK) PA 2023 70140

(51) Int. Cl. A61C 9/00; G06T 7/11

(52) U.S. Cl. CPC A61C 9/0053; G06T 7/11; G06T 2207/10048; G06T 2207/10116; G06T 2207/10132; G06T 2207/20081; G06T 2207/20084; G06T 2207/30036

(57) ABSTRACT

The handheld intraoral scanner system includes a handheld intraoral scanner configured to acquire light information reflected from a three-dimensional dental object during a scanning session and further includes one or more processors operably connected to the handheld intraoral scanner device. The processors are configured to determine a position of a 2D image of a dental object relative to a virtual 3D model of the dental object using a first-, a second-, and a third neural network, and an algorithm. The one or more processors is further configured to superimposition the 2D image of the dental object on a corresponding dental object of the virtual 3D model, or vice versa.

### FIELD

The disclosure relates in general to determining a position of a 2D image of a dental object relative to a virtual 3D model of the dental object, and in particular to superimposing a 2D image of a dental object on a virtual 3D model of the dental object, and simultaneous display of information from the 2D image and the virtual 3D model.

### BACKGROUND

A dental practitioner may occasionally need to view diagnostics or health information from different sources of information, such as bitewing x-rays, panoramic x-rays, ultrasound images, infrared images, or virtual 3D models, simultaneously. Such simultaneous viewing allows the dental practitioner efficiently and conveniently to obtain more details about a patient's dental condition. This is beneficial, since diagnostics or health information associated with each type of information source may be viewed at the same time.

It would thus be more efficient and convenient for a dentist, to view e.g., a bitewing (x-ray image of a part of the dentition) of a patient, and a virtual 3D model of the dentition of the patient simultaneously.

In some situations, it is even more beneficial to view an image associated with a dental condition, such as a bitewing, superimposed on a virtual 3D model of the dentition of the patient having the dental condition, or vice versa, such that the virtual 3D model superimposed on the bitewing.

The expression “superimpose” is understood as “to place over or above something”, thus, by superimposing an x-ray image of teeth on a virtual 3D model of a dentition comprising the teeth, is understood as, to place the x-ray image of the teeth over the same teeth (corresponding teeth) of the virtual 3D model.

Superimposing medical 2D images such as bitewings, panoramic x-rays, CBCT scans, and infrared images, on virtual 3D models of dentitions or parts of dentitions, is a commonly known practice performed, to allow dental practitioners to view diagnostics or health information from both the medical 2D images and the virtual 3D model.

Superimposing images on virtual 3D models requires knowledge of the angle from where the image was taken (e.g. when the image is a bitewing), or data points of the image (e.g. when the images are from a CBCT scan), in order to superimpose the image on the corresponding position on the virtual 3D model.

In some situations however, such information about the angle from where an image was taken, or data points, are not available. For instance, when a dental practitioner receives an x-ray image (e.g. a bitewing) of a patient taken at an earlier date and at another place, and where the dental practitioner would like to see the x-ray image superimposed on its corresponding position on a virtual 3D model of the patient's dentition, superimposing may not be possible, since a such image does not show or contain explicit information about the angle from where the image was taken, or data points. Superimposing a such image on a corresponding position on a virtual 3D model sufficiently accurate for practical purposes, may in such situations not be possible.

### SUMMARY

An aspect of the present disclosure is to allow for superimposing any arbitrary image of a dental object onto a virtual 3D model of the dental object.

A further aspect of the present disclosure is to allow a dental practitioner to efficiently and conveniently view any arbitrary image of a dental object superimposed on a virtual 3D model of the dental object, and simultaneously viewing diagnostics or health information from the image and the virtual 3D model.

According to the aspect, a handheld intraoral scanner system configured to determine a position of a segmented 2D image of a dental object relative to a segmented virtual 3D model of the dental object is disclosed. The handheld intraoral scanner system may comprise a handheld intraoral scanner that may be configured to acquire light information reflected from a three-dimensional dental object during a scanning session, wherein the scanning session is a period of time in which a scan is performed using the handheld intraoral scanner. The light information may be intraoral scan data, and may be configured to be used to generate or update a virtual 3D model of a dental object. The dental object may be a tooth, a part of a tooth, teeth, an upper or lower jaw or parts of them, a whole dentition or a part of a dentition, and/or a gingiva or part thereof.

The handheld intraoral scanner system may further comprise a 2D image of a dental object. The 2D image may be any arbitrary image displaying a dental object or a part thereof. The 2D image may for example be an x-ray image (e.g. a bitewing or a 2D panoramic dental image), an infrared or near-infrared image, an ultrasound image, a photographic image, etc. The 2D image may further be obtained by the handheld intraoral scanner, a camera, a second handheld intraoral scanner, or an extraoral scanner. The 2D image may be obtained by an infra-red or near-infra-red image capturing device, such as a handheld infra-red scanner or handheld near-infra-red scanner. The system may further comprise a memory unit that is configured to load the 2D image of the dental object.

The handheld intraoral scanner system may further comprise one or more processors. The one or more processors may be operably connected to the handheld intraoral scanner. The one or more processors may be configured to determine, in real time, surface information from the light information or intraoral scan data, and generate a virtual 3D model (a three-dimensional surface model) of a dental object using the surface information. The one or more processors may comprise one processor, such as a CPU (central processing unit), with one or more processor cores. The one or more processors may comprise more than one processor, such as a plurality of CPUs, such as a processing cluster, wherein each of the plurality of CPUs includes one or more processor cores. The handheld intraoral scanner and the one or more processors may be separate entities, which may allow the processing of the light information or intraoral scan data to occur outside the intraoral scanner and may thus allow for using remote resources or may allow for a cloud-based processing.

The one or more processors may thus for example all or partly be located inside the handheld intraoral scanner, may all or partly be located in a laptop computer, desktop computer, tablet computer, smartphone, or smart tv, or may all or partly be located remotely in a server as a cloud-based computing and operably connected to the handheld intraoral scanner by cable, by a wireless network through a router, or Internet connection.

The one or more processors may further be distributed between two or more of the above mentioned locations. For example, some of the one or more processors may be located in the handheld intraoral scanner in the form of a CPU (central processing unit), while some other of the one or more processors may be located in a desktop computer in the immediate vicinity of the handheld intraoral scanner, such as in a same clinic at a dentist, and while yet some other of the one or more processors may be located in a remote server in a “cloud” as a cloud based computing service, and connected to the handheld intraoral scanner or to the desktop computer via the internet.

The one or more processors may further be configured to segment 2D images of dental objects. The system may comprise a first neural network that is trained to segment any dental objects of 2D images. The one or more processors is configured to segment the 2D image by using the first neural network. The segmenting may be performed using the first neural network, that may be trained to segment any dental objects in images. The first neural network may be trained by feeding its algorithm with a large number of images of dental objects such as teeth, parts of teeth, gingiva, and parts of gingiva, and feeding its algorithm with values or information for each image and/or dental object in an image, such as, whether what is in the image is a tooth, teeth, part of a tooth, part of dentition, dentition, dental appliances such as aligners or braces, or part of a gingiva, etc. A such training may allow the first neural network to recognize a dental object that is depicted in images, and may allow the first neural network to identify any dental object in any image, and segmenting that image. The system may further be configured to identify the dental object by determining a tooth number or teeth numbers in the segmented 2D image according to the Universal Tooth Numbering System.

The first neural network may segment the 2D image by any methods of image segmentation known in the art, such as thresholding, clustering, edge detection, or image segmentation neural networks, such as pulse-coupled neural networks or convolutional neural networks, such as U-net.

Segmenting an image may be beneficial, since figure resembling a dental object in the image, may be identified.

For example, an x-ray image of 4 teeth from the upper jaw and 4 teeth from the lower jaw may be segmented by the first neural network using any of the above-mentioned methods, resulting in a segmentation of the x-ray image. A such segmentation is beneficial, since this may allow for a recognition and identification of each tooth in the x-ray image.

The one or more processors may further be configured to obtain a first group of 2D information of the segmented 2D image that has been segmented using the first neural network. The first group of 2D information may be data points. The data points may comprise 2D coordinates. The first group of 2D information may be pixels. The one or more processors may thus be configured to determine data points or pixels from a segmented 2D image of a dental object, and determine for each pixel, to which part of the image the pixel is associated with. A such determination may be performed by the first neural network by recognizing a contour of a dental object in a 2D image, and determining which pixels are present within a dental object defined by the recognized contour.

A such determination is beneficial, since this allows for a selection of an element in the 2D image individually and separately from the rest of other elements in the 2D image, and may allow for subsequent modification of that element.

The one or more processors may be configured to determine pixels from the segmented x-ray image, and determine for each pixel, which tooth the pixel is associated with. A group of pixels depicting a certain tooth, may thus be selected and modified, thereby selecting and modifying the tooth individually and separately from the rest of the teeth shown in the x-ray image, e.g. by modifying a position, orientation, and/or a size of an individual pixel, a group of pixels, the tooth, a part of the tooth, several teeth, a whole dentition or a part thereof.

The one or more processors may be configured to segment virtual 3D models of dental object. The system may further comprise a second neural network that may be trained to segment any dental objects of virtual 3D models. The one or more processors may be configured to segment the virtual 3D model by using the second neural network. The segmenting may be performed using the second neural network, that may be trained to segment any dental objects in a virtual 3D model. The second neural network may be trained by feeding its algorithm with a large number of virtual 3D models of dental objects such as teeth, parts of teeth, gingiva, parts of gingiva, an upper jaw, a lower jaw, a whole dentition, dental appliances such as aligners or braces, etc., and feeding its algorithm with values or information for each virtual 3D model and/or dental object in a virtual 3D model, such as whether what is in the virtual 3D model is a tooth, teeth, part of a tooth, part of dentition, dentition, dental appliances such as aligners or dental braces, or part of a gingiva. A such training may allow the second neural network to recognize the dental object that is represented in the virtual 3D model, and may allow the second neural network to identify any dental objects in a virtual 3D model, and segmenting that virtual 3D model. The system may further be configured to identify the dental object by determining a tooth number or teeth numbers in the virtual 3D model according to the Universal Tooth Numbering System.

The second neural network may segment the virtual 3D model of the dental object by using any of known 3D segmenting methods, such as polygon triangulation, space sweep, surface decomposition, etc.

Segmenting the virtual 3D model of the dental object may be beneficial, since a virtual 3D model containing a part or parts resembling a dental object, may be recognized, identified, and separated into individual parts. Each individual part of the dental object in the virtual 3D model may thus be identified.

For example, a virtual 3D model of a complete dentition comprising an upper jaw, a lower jaw, teeth, and a part of a gingiva, may be segmented by the second neural network using any of the above mentioned methods, resulting in a segmentation of the virtual 3D model. A such segmentation is beneficial, since this may allow for a determination, recognition, and identification of each tooth individually and the gingiva in the virtual 3D model.

A such determination, recognition, and identification is beneficial, since this allows for a selection of an element in the virtual 3D model of a dental object individually and separately from the rest of other elements in the virtual 3D model, and may allow for subsequent modification of that element.

The one or more processors may be configured to determine an initial position of a segmented 2D image of a dental object relative to a segmented virtual 3D model of the dental object. The system may further comprise a third neural network that is trained to determine an initial position of a segmented 2D image of a dental object relative to any corresponding dental object of a segmented virtual 3D model. The one or more processors may be configured to determine an initial position of the segmented 2D image relative to the segmented virtual 3D model by using the third neural network.

The initial position of the segmented 2D image may be determined relative to a corresponding dental object of the segmented virtual 3D model that corresponds to the dental object of the segmented 2D image.

Determining the initial position may be performed using the third neural network, that may be trained to determine an initial position of any segmented 2D image of a dental object relative to a segmented virtual 3D model of the dental object.

The third neural network may be trained by feeding its algorithm with a large amount of segmented 2D images of dental objects and a large amount of segmented virtual 3D models of dental objects.

The third neural network may further be fed with information about where each dental object in each segmented 2D image of the large amount of segmented 2D image belong on each segmented virtual 3D models of the large amount of segmented virtual 3D models, comprising the same dental object.

The one or more processors may be configured to arrange the segmented 2D image relative to the segmented virtual 3D model by performing a positioning of a 2D image plane relative to the segmented virtual 3D model, or, vice versa, by using the third neural network. The 2D image plane may be a plane in space containing the segmented 2D image.

The third neural network may perform a first guess of an initial position relative to the segmented virtual 3D model, which may be based on an approximate position of a dental object of a segmented 2D image, relative to a corresponding dental object, that may correspond to the dental object present in the segmented 2D image. The third neural network may be trained to perform a first guess to determine an initial position of any dental object of a segmented 2D image relative to any corresponding dental object of a segmented virtual 3D model.

Determining an initial position of a segmented 2D image of a dental object or of a dental object in a segmented 2D image, relative to a virtual 3D model of the dental object may allow for a more efficient arranging, positioning, superimposing, etc. since the one or more processors, using the third neural network, may position the segmented 2D image of the dental object or the dental object of the segmented 2D image relatively close to and in a nearby vicinity of the corresponding dental object in the virtual 3D model of the dental object.

The expression “relatively close” and “in a nearby vicinity” is understood such that the segmented 2D image or the dental object in the segmented 2D image may be positioned closer to the upper- or lower jaw in the virtual 3D model, where the corresponding dental object is located, than to the other upper- or lower jaw, and furthermore positioned closer to the right- or left hand side of the virtual 3D model where the corresponding dental object is located, than to the other right- or left hand side of the virtual 3D model.

Hereby, a superimposing may be achieved that requires less processing steps or power, than without the initial positioning of the segmented 2D image relative to the virtual 3D model, or vice versa.

The expression “corresponding dental object” is understood as referring to a same dental object in the virtual 3D model as in a 2D image of the dental object, or vice versa. The expression may further be understood as referring to a same position of a dental object in a virtual 3D model as a position in a 2D image of the dental object, or vice versa.

For example, a dental object in a 2D image may be a first molar tooth on the upper jaw and on the right-hand side of a patient. A corresponding dental object (corresponding to the above-mentioned dental object) in a virtual 3D model of the dental object, is also the first molar tooth on the upper jaw and on the right-hand side of the patient, in the virtual 3D model.

In a situation where the first molar tooth on the upper jaw and on the right-hand side of the patient in the 2D image from the above example has been removed after the 2D image was taken, and the tooth substituted with e.g. a dental implant, the corresponding dental object in a virtual 3D model that was subsequently obtained, would be the dental implant.

In another situation, where the first molar tooth from the above example has been removed after the 2D image was taken, but not subsequently substituted with e.g. a dental implant or an artificial tooth, and thereby left as an empty space in the virtual 3D model, then the corresponding dental object in a virtual 3D model that is subsequently obtained, refers to the position where the first molar tooth should or would have been located.

In yet another situation where the dental object in a 2D image is a left-hand side of a lower jaw, the corresponding dental object in a virtual 3D model is also the left-hand side of the lower jaw in the virtual 3D model.

For example, given a segmented x-ray image of a second molar tooth in the upper left-hand side of a patient's dentition, and a segmented virtual 3D model of the upper jaw of the patient including the second molar tooth, the one or more processors may be configured to use the third neural network to determine an initial position of the second molar tooth of the segmented x-ray image relative to the segmented virtual 3D model, by performing a first guess. The third neural network may determine that what is depicted in the segmented x-ray image is a second molar tooth on the left-hand side of a dentition. The third neural network may further determine, e.g. by recognizing a contour of the surroundings of the second molar tooth, such as other teeth or gingiva, that the second molar tooth is on the upper jaw of the patient. The third neural network may hereafter determine the second molar tooth in the upper left-hand side of the virtual 3D model, and determine a position that is in the vicinity of that second molar tooth.

The one or more processors may further be configured to obtain a 2D projection of the segmented virtual 3D model of the dental object. The 2D projection may comprise 2D information, hereinafter throughout the disclosure referred to as a second group of 2D information, from the segmented virtual 3D model of the dental object. The one or more processors may further be configured to obtain the second group of 2D information of the 2D projection of the segmented virtual 3D model of the dental object. The one or more processors may be configured to obtain the 2D projection using an algorithm. The algorithm may further be configured to obtain the 2D projection of the segmented virtual 3D model of the dental object. The algorithm may further be configured to obtain or determine the second group of 2D information. The second group of 2D information may be 2D information of the 2D projection.

Obtaining a 2D projection of the segmented virtual 3D model of the dental object from an initial position may allow obtaining a second group of 2D information that are associated with the segmented virtual 3D model from a position that is in the vicinity of a corresponding dental object in the segmented virtual 3D model, which second group of 2D information may be used in subsequent processes that may allow for a faster and more efficient superimposing process.

The 2D projection may be an instant image of the segmented virtual 3D model of the dental object from the initial position. The 2D projection may thus be a screenshot of the segmented virtual 3D model of the dental object as viewed from the initial position. The 2D projection may thus comprise 2D information, that may be pixels.

The one or more processors may be configured to use an algorithm to take an instant image (e.g. a screenshot) of the segmented virtual 3D model of the dental object from the initial position that was determined by using the third neural network. The algorithm may further be configured to obtain a second group of 2D information that may be the pixels of the screenshot (the instant image).

For example, the one or more processors may forward information about the determined initial position that was obtained using the third neural network to the algorithm. The one or more processors may then use the algorithm to take a screenshot (an instant 2D image) of the segmented virtual 3D model of the dental object as viewed from the determined initial position, thereby acquiring a 2D projection (the screenshot) of the segmented virtual 3D model, comprising 2D information (second group of 2D information) that are the pixels of the screenshot (the instant image, the 2D projection).

The 2D projection may be a set of 2D information, which may be a set of 2D data points of the segmented virtual 3D model, onto a projection plane in the determined initial position.

The one or more processors may be configured to forward information about the determined initial position, that was obtained using the third neural network, to the algorithm. The algorithm may be configured to arrange a projection plane in the determined initial position using the forwarded information. The algorithm may further be configured to extract 2D data points from the segmented virtual 3D model of the dental object, and arrange them on a corresponding position on the projection plane. The algorithm may further be configured to assign a depth value for each arranged 2D data point on the projection plane such, that the projection plane contains 2D data points having 2D coordinates and a depth value. The one or more processors may be configured to obtain a 2D projection of the segmented virtual 3D model onto a projection plane by acquiring another 2D image of the segmented virtual 3D model from the determined initial position.

For example, the one or more processors may forward information about the determined initial position that was obtained using the third neural network to the algorithm. The algorithm may use the forwarded information to arrange a projection plane in the determined initial position. The algorithm may then extract 2D data points from the segmented virtual 3D model of the dental object, and arrange them on a corresponding position in the projection plane. The algorithm may then assign a depth value for each arranged data point on the projection plane.

The one or more processors may be configured to align the first group of 2D information of the segmented 2D image with the second group of 2D information of the 2D projection of the segmented virtual 3D model. The alignment may be performed using the algorithm. The algorithm may be configured to arrange the first group of 2D information on the second group of 2D information. The algorithm may further be configured to arrange the segmented 2D image on the 2D projection. The algorithm may further be configured to align the first group of 2D information with the second group of 2D information by changing a position, an orientation, and/or a size of the first group of 2D information of the 2D image. The one or more processors may be configured to modify a position, orientation, and/or size of the segmented virtual 3D model using the algorithm.

Aligning the first group of 2D information with the second group of 2D information, or the segmented 2D image with the 2D projection of the segmented virtual 3D model, may allow for determining which 2D information (pixels or data points) between the segmented 2D image and the 2D projection coincide with each other.

The one or more processors may be configured to determine a first number of coinciding 2D information between the first group of 2D information and the second group of 2D information. The one or more processors may be configured to determine the first number of coinciding 2D information using the algorithm. The algorithm may be configured to determine the first number of coinciding 2D information.

Determining a first number of coinciding 2D information between the segmented 2D image and the 2D projection may allow for determining whether the initial position is acceptable for superimposing the segmented 2D image on the segmented virtual 3D model, or a different position of the segmented 2D image relative to the segmented virtual 3D model is needed.

The expression “different position(s)” or “another position(s)” is throughout this disclosure understood as relating to another position, orientation, size, shape, or direction.

The algorithm may be configured to determine a first number of coinciding 2D information. The first number of coinciding 2D information may be 2D information from the first group of 2D information and 2D information from the second group of 2D information that are identical, similar to each other, have the same colour, have the same size, have the same graphic content, have the same position and/or orientation, or are arranged within the same segmented dental object, e.g. are arranged within a contour of the same dental object.

For example, the algorithm may obtain a segmented 2D image of a tooth, wherein a first group of pixels are within a contour of the tooth, and another image, which is a screenshot of a virtual 3D model of the tooth taken from an initial position, and wherein a second group of pixels are within a contour of the tooth in the screenshot. The algorithm determines or identifies the pixels that are of the first group of pixels in the segmented 2D image and the pixels that are of the second group of pixels in the screenshot. The algorithm then determines a number of coinciding pixels, by determining how many pixels from both groups of pixels (the first group of pixels and the second group of pixels) are within the depicted tooth in both images (the segmented 2D image and the screenshot).

The algorithm may be configured to use one of several known methods for determining coinciding pixels or segmented objects in different images, such as the “Intersection over Union”-method (IoU), where a degree of overlap between an object in two images is detected, or where a probability for objects in two segmented images intersecting, is determined.

The one or more processors may further be configured to repeatedly determine another number of coinciding 2D information between the first group of 2D information and the second group of 2D information. The another number of coinciding 2D information may be determined using different positions of the segmented 2D image relative to the segmented virtual 3D model. The one or more processors may be configured to repeatedly determine the another number of coinciding 2D information, until the another number of coinciding 2D information reaches a predetermined number of coinciding 2D information.

The one or more processors may repeatedly determine the another number of coinciding 2D information and determining the different positions, using the algorithm. The algorithm may be configured to determine the different positions. The algorithm may further be configured to repeatedly determine the another number of coinciding 2D information.

The algorithm may thus be configured to obtain the 2D projection and the second group of 2D information, align the first group of 2D information with the second group of 2D information and determine the first number of coinciding 2D information, and repeatedly determine the another number of coinciding 2D information between the first group of 2D information and the second group of 2D information using the different positions of the segmented 2D image relative to the segmented virtual 3D model, until the another number of coinciding 2D information reaches the predetermined number of coinciding 2D information.

For example, the algorithm may determine four different positions, one to the right, one to the left, one above, and one below the initial position. For every one of the four different positions, the above described process of determining the another number is repeated, thereby determining four another number of coinciding 2D information. The algorithm may then determine which of the four another numbers of coinciding 2D information is the largest number, and based on the largest number, determine where to arrange a next different position, so that a larger number of coinciding 2D information may be obtained for every repetition.

The predetermined number may be a fixed number, a number that is based on a user input, or a calculated number, such as a ratio. The one or more processors or algorithm is configured to terminate the process of determining another number of coinciding 2D information, when the another number of coinciding 2D information reaches the predetermined number or exceeds the predetermined number. The predetermined number may be a number of pixels, an index, or a ratio.

The one or more processors may further be configured to superimpose the segmented 2D image on the segmented virtual 3D model. The one or more processors may be configured to superimpose the segmented 2D image on the segmented virtual 3D model in the position at which the another number of coinciding 2D information has reached the predetermined number of coinciding 2D information.

The superimposing may be performed by arranging the segmented 2D image of the dental object on the segmented virtual 3D model of the dental object, or vice versa, where the segmented virtual 3D model of the dental object is arranged on the segmented 2D image of the dental object. In another embodiment, only a part of the segmented 2D image is arranged on the segmented virtual 3D model, or vice versa, where only a part of the segmented virtual 3D model is arranged on the segmented 2D image.

For example, only a dental object of the segmented 2D image of a dental object is arranged on the corresponding dental object of a segmented virtual 3D model of the dental object, or vice versa.

The superimposing may further imply that the segmented 2D image that is superimposed on the segmented virtual 3D model, may be made partly transparent, such that the dental object in the segmented 2D image may be visible and the dental object of the segmented virtual 3D model may be visible, and vice versa, wherein the dental object of the segmented virtual 3D model that is superimposed on the segmented 2D image may be made partly transparent, such that the dental object of the segmented virtual 3D model may be visible, and the dental object of the segmented 2D image may be visible.

Superimposing the 2D image on the segmented virtual 3D model in the position at which the another number of coinciding 2D information has reached the predetermined number of coinciding 2D information may allow the superimposing to be performed at an optimal number of coinciding 2D information, and may thus be a sufficiently precise superimposing.

In an example where the 2D information are pixels, and where a predetermined number of coinciding pixels is a first specific number, the one or more processors, using the third neural network, determines another position of the segmented 2D image relative to the segmented virtual 3D model. In a subsequent process, the one or more processors, using the algorithm, obtains a new screenshot of the segmented virtual 3D model from the determined another position, obtains a second group of pixels from the screenshot, aligns the segmented 2D image on the screenshot, and determines a second specific number of coinciding pixels between the segmented 2D image and the screenshot, wherein the second specific number of coinciding pixels is larger than the first specific number. The one or more processors using the algorithm determines that the number of coinciding pixels is larger than the predetermined number of coinciding pixels, and uses the determined another position to superimpose the segmented 2D image on the segmented virtual 3D model in the determined another position.

The system may comprise a display. The system may further be configured to displaying the superimposed segmented 2D image on the segmented virtual 3D model on the display, or displaying a superimposed segmented virtual 3D model on a segmented 2D image. The system may further be configured to displaying diagnostics and/or health data from the 2D image and from the intraoral scan data (or virtual 3D model) on the display simultaneously.

The diagnostics and/or health data may comprise dental caries (tooth cavities and decay), gum disease (gingivitis, periodontal disease, and peri-implant disease), bone loss, tooth wear, dental cracks and fractures, dental plaque, oral diseases (cancer), etc.

A dentist may for example view on a display a bitewing (x-ray image) of a patient's dentition superimposed on a virtual 3D model of the patient's dentition. The dentist may view an infection of the gums from the bitewing, and may view tooth wear on the patient's teeth from the virtual 3D model. The dentist may thus efficiently and conveniently view several diagnostics and health information associated with the patient's dentition simultaneously, without having to switch between a view of the bitewing and a view of the virtual 3D model. The dentist is furthermore not required to acquire a bitewing containing information indicating from which angle the bitewing was taken, but can rather use any bitewing of the patients dentition.

According to the aspect, a method is provided for determining a position of a segmented 2D image of a dental object relative to a segmented virtual 3D model of the dental object.

The 2D image may be any arbitrary image displaying a dental object or a part thereof. For example, the 2D image may be an x-ray image (e.g. a bitewing or a 2D panoramic dental image), an infra-red (IR) image, a near-infra-red (NIR) image, an ultrasound image, a photographic image, or any arbitrary image.

The dental object may be a tooth, a part of a tooth, teeth, an upper or lower jaw or parts of them, a whole dentition or a part of a dentition, and/or a gingiva or part thereof.

The virtual 3D model may be generated based on light information of a 3D scanner. The 3D scanner may be a lab scanner configured to scan a dental impression, or may be a handheld intraoral scanner. The light information may be scan data, such as intraoral scan data.

The 2D image of the dental object may further be obtained by the handheld intraoral scanner, a camera, a second handheld intraoral scanner, or an extraoral scanner. The 2D image of the dental object may in another aspect be acquired by loading the 2D image from a memory unit.

The method may comprise a step of determining a position of a segmented 2D image of a dental object relative to a segmented virtual 3D model of the dental object using one or more processors.

The one or more processors may be operably connected to a handheld intraoral scanner. The one or more processors may be configured to determine, in real time, surface information from the light information or intraoral scan data, and generate the virtual 3D model (a three-dimensional surface model) of the dental object using the surface information. The one or more processors may comprise one processor, such as a CPU (central processing unit), with one or more processor cores. The one or more processors may comprise more than one processor, such as a plurality of CPUs, such as a processing cluster, wherein each of the plurality of CPUs includes one or more processor cores. The handheld intraoral scanner and the one or more processors may be separate entities, which may allow the processing of the light information or intraoral scan data to occur outside the intraoral scanner and may thus allow for using remote resources or may allow for a cloud-based processing.

The one or more processors may thus for example all or partly be located inside the handheld intraoral scanner, may all or partly be located in a laptop computer, desktop computer, tablet computer, smartphone, or smart tv, or may all or partly be located remotely in a server as a cloud-based computing and operably connected to the handheld intraoral scanner by cable, by a wireless network through a router, or Internet connection. The one or more processors may further be distributed between two or more of the above mentioned locations. For example, some of the one or more processors may be located in the handheld intraoral scanner in the form of a CPU (central processing unit), while some other of the one or more processors may be located in a desktop computer in the immediate vicinity of the handheld intraoral scanner, such as in a same clinic at a dentist, and while yet some other of the one or more processors may be located in a remote server in a “cloud” as a cloud based computing, and connected to the handheld intraoral scanner or to the desktop computer via the internet.

The method may comprise a step of acquiring a virtual 3D model of the dental object based on light information of the dental object, such as intraoral scan data of the dental object. The virtual 3D model of the dental object may be acquired by loading the virtual 3D model from a file, by downloading the virtual 3D model from a network such as the internet, by performing an intraoral 3D scan of the dental object, or by performing a lab-scan of a dental impression comprising the dental object. Acquiring the virtual 3D model may be performed using the one or more processors.

The method may further comprise a step of acquiring a 2D image of the dental object. The 2D image may be an x-ray image (e.g. a bitewing or a panoramic x-ray), an infra-red (IR) image, a near-infra-red (NIR) image, an ultrasound image, a photographic image, or any other 2D image. The 2D image of the dental object may be acquired by loading the 2D image from a file, by downloading the 2D image from a network such as the internet, or by taking an instant image, such as with a camera or a screenshot, of the dental object.

The method may further comprise a step of segmenting the 2D image of the dental object. Segmenting the 2D image may be performed using a first neural network, that may be trained to segment any dental objects of images. The first neural network may be trained by feeding its algorithm with a large number of images of dental objects such as teeth, parts of teeth, gingiva, and parts of gingiva, and feeding its algorithm with values or information for each image and/or dental object in an image, whether what is in the image is a tooth, teeth, part of a tooth, part of dentition, dentition, dental appliances such as aligners or braces, or part of a gingiva, etc. A such training may allow the first neural network to recognize the dental object that is depicted in the images, and may allow the first neural network to identify any dental object in any image, and segmenting that image. Identifying the dental object may be performed by determining a tooth number or teeth numbers according to the Universal Tooth Numbering System.

The first neural network may segment the 2D image by any known methods of image segmentation known in the art, such as thresholding, clustering, edge detection, or image segmentation neural networks, such as pulse-coupled neural networks or convolutional neural networks, such as U-net.

Segmenting an image may be beneficial, since a figure resembling a dental object in the figure, may be identified.

For example, an x-ray image of 4 teeth from the upper jaw and 4 teeth from the lower jaw, with no digital information of dental significance, may be segmented by the first neural network using the above mentioned method, resulting in a segmentation of the x-ray image. A such segmentation is beneficial, since this may allow for a recognition and identification of each tooth in the x-ray image.

The method may further comprise a step of obtaining a first group of 2D information of the segmented 2D image.

The first group of 2D information of the segmented 2D image may be obtained using the one or more processors.

The first group of 2D information may be data points. The data points may comprise 2D coordinates. In another aspect, the first group of 2D information may be pixels. The one or more processors may thus be configured to determine data points or pixels from a segmented 2D image of a dental object, and determine for each pixel or data point, to which part of the image the pixel or data point is associated with. A such determination may be performed by the first neural network by recognizing a contour of a dental object in a 2D image, and determining which pixels or data points are present within a dental object defined by the recognized contour.

A such determination is beneficial, since this allows for a selection of an element in the 2D image individually and separately from the rest of other elements in the 2D image, and may allow for modification of that element.

Continuing the example above, the one or more processors may be configured to determine pixels from the segmented x-ray image, and determine for each pixel, which tooth the pixel is associated with. A group of pixels depicting a certain tooth, may thus be selected and modified, thereby selecting and modifying the tooth individually and separately from the rest of the teeth shown in the x-ray image, e.g. by modifying a position, orientation, and/or a size of the tooth, a part of the tooth, several teeth, a whole dentition or a part thereof, an individual pixel or a group of pixels.

The method may comprise a step of segmenting the virtual 3D model of the dental object. Segmenting the virtual 3D model may be performed using a second neural network, that may be trained to segment any dental objects of virtual 3D models. The second neural network may be trained by feeding its algorithm with a large number of virtual 3D models of dental objects such as teeth, parts of teeth, gingiva, parts of gingiva, an upper jaw, a lower jaw, a whole dentition, dental appliances such as aligners or braces, etc. and feeding its algorithm with values or information for each virtual 3D model and/or dental object in a virtual 3D model, whether what is in the virtual 3D model is a tooth, teeth, part of a tooth, part of dentition, dentition, dental appliances such as aligners or dental braces, or part of a gingiva. A such training may allow the second neural network to recognize the dental object that is present in the virtual 3D model, and may allow the second neural network to identify any dental object in any virtual 3D model, and segmenting that virtual 3D model.

The second neural network may segment the virtual 3D model of the dental object by using any of known 3D segmenting methods such as polygon triangulation, space sweep, surface decomposition, etc.

Segmenting the virtual 3D model of the dental object may be beneficial, since a virtual 3D model containing a part or parts resembling a dental object, may be recognized, identified, and separated into individual parts. Each individual part of the dental object in the virtual 3D model may thus be identified.

For example, a virtual 3D model of a complete dentition comprising an upper jaw, a lower jaw, teeth, and a part of a gingiva, may be segmented by the second neural network using any of the above mentioned methods, resulting in a segmentation of the virtual 3D model. A such segmentation is beneficial, since this may allow for a determination, recognition and identification of each tooth and the gingiva in the virtual 3D model.

A such determination, recognition, and identification is beneficial, since this allows for a selection of an element in the virtual 3D model of a dental object individually and separately from the rest of other elements in the virtual 3D model, and may allow for modification of that element.

Continuing the above example with the virtual 3D model, the one or more processors may be configured to use the second neural network to segment the virtual 3D model and may be configured to modify a position, orientation, and/or size of the segmented virtual 3D model using an algorithm.

The method may further comprise a step of determining an initial position of the segmented 2D image of the dental object relative to the segmented virtual 3D model of the dental object.

A dental object may be a tooth, teeth, part of a tooth, part of dentition, dentition, dental appliances such as aligners or dental braces, or part of a gingiva.

The initial position may be determined using a third neural network.

Determining the initial position may be performed using a third neural network, that may be trained to determine an initial position of any segmented 2D image of a dental object relative to a segmented virtual 3D model of the dental object, or vice versa. The third neural network may further be trained to determine an initial position of a segmented 2D image of a dental object relative to any corresponding dental object of a segmented virtual 3D model, or vice versa. The third neural network may be trained by feeding its algorithm with a large amount of segmented 2D images of dental objects and a large amount of segmented virtual 3D models of dental objects, and is also fed with information about where the segmented dental objects in the 2D images belong on the segmented virtual 3D model. The third neural network may perform a first guess of an initial position relative to the segmented virtual 3D model, which may be based on an approximate position relative to a corresponding dental object that may correspond to the dental object present in the segmented 2D image. The third neural network may thus be configured to determine the initial position of the dental object of the segmented 2D image relative to the corresponding dental object of the segmented virtual 3D model by performing a first guess. Thus, the method may comprise a step of determining an initial position of the segmented 2D image relative to a corresponding dental object of the segmented virtual 3D model that corresponds to the dental object of the segmented 2D image.

Determining an initial position of a segmented 2D image of a dental object or of a dental object in a segmented 2D image, relative to a virtual 3D model of the dental object may allow for a more efficient arranging, positioning, superimposing, etc. since the third neural network, may position the segmented 2D image of the dental object or the dental object of the segmented 2D image relatively close to and in a nearby vicinity of the corresponding dental object in the virtual 3D model of the dental object, or vice versa, such that a dental object of a segmented virtual 3D model is positioned relatively close and in a nearby vicinity of a corresponding dental object of a segmented 2D image.

The expression “relatively close” and “in a nearby vicinity” is understood such, that the segmented 2D image or the dental object in the segmented 2D image may be positioned closer to the upper- or lower jaw in the virtual 3D model, where the corresponding dental object is present in the virtual 3D model, than to the other upper- or lower jaw and further positioned closer to the right- or left hand side of the virtual 3D model where the corresponding dental object in the virtual 3D model is present, than to the other right- or left hand side of the virtual 3D model.

Hereby may be achieved a superimposing that requires less processing than without the initial positioning of the segmented 2D image relative to the segmented virtual 3D model, or vice versa.

The expression “corresponding dental object”, is understood such as referring to a same dental object in the virtual 3D model as in a 2D image of the dental object, or vice versa. The expression may further be understood as referring to a same position of a dental object in a virtual 3D model as a position in a 2D image of the dental object, or vice versa.

For example, a dental object in a 2D image may be a first molar tooth on the upper jaw and the right-hand side of a patient. A corresponding dental object (corresponding to the above-mentioned dental object) in a virtual 3D model of the dental object, is the first molar tooth on the upper jaw and on the right-hand side of the patient, in the virtual 3D model.

In a situation where the first molar tooth on the upper jaw and the right-hand side of the patient in the 2D image from the above example has been removed after the 2D image was taken, and the tooth substituted with e.g. a dental implant, the corresponding dental object would in this situation be the dental implant.

In another situation, where the first molar tooth from the above example has been removed after the 2D image was taken, but not subsequently substituted with e.g. a dental implant or an artificial tooth, and thereby left as an empty space in the virtual 3D model, then the corresponding dental object refers to the position where the first molar tooth would have been in the virtual 3D model.

In yet another situation where the dental object in a 2D image is a left-hand side of a lower jaw, the corresponding dental object in a virtual 3D model is the left-hand side of the lower jaw in the virtual 3D model of the dental object.

For example, given a segmented x-ray image of a second molar tooth in the upper left-hand side of a patient's dentition, and a segmented virtual 3D model of the upper jaw of the patient including the second molar tooth, the third neural network may be used to determine an initial position of the second molar tooth of the segmented x-ray image relative to the segmented virtual 3D model, by performing a first guess. The third neural network may determine that what is depicted in the segmented x-ray image is a second molar tooth on the left-hand side of a dentition. The third neural network may further determine, e.g. by recognizing a contour of the surroundings of the second molar tooth, such as other teeth or gingiva, that the second molar tooth is on the upper jaw of the patient. The third neural network may subsequently determine the second molar tooth in the upper left-hand side of the virtual 3D model, and determine a position that is in the vicinity of that second molar tooth.

The method may comprise a step of obtaining a 2D projection of the segmented virtual 3D model. The 2D projection may be onto a projection plane. Obtaining the 2D projection may be performed by acquiring another 2D image that is of the segmented virtual 3D model as viewed from the determined initial position.

The method may further comprise a step of obtaining a second group of 2D information of the 2D projection of the segmented virtual 3D model.

The method may comprise a step of obtaining the 2D projection of the segmented virtual 3D model of the dental object using the one or more processors. The 2D projection may comprise 2D information from the segmented virtual 3D model of the dental object. The method may comprise a step of obtaining the second group of 2D information of the 2D projection of the segmented virtual 3D model of the dental object using the one or more processors. The one or more processors may be configured to obtain the 2D projection using an algorithm. The algorithm may further be configured to obtain the 2D projection of the segmented virtual 3D model of the dental object. The algorithm may further be configured to obtain or determine the second group of 2D information. The second group of 2D information may be 2D information of the 2D projection.

Obtaining a 2D projection of the segmented virtual 3D model of the dental object from the initial position may allow obtaining a second group of 2D information that are associated with the segmented virtual 3D model from a position that is in the vicinity of the segmented virtual 3D model, which second group of 2D information may be used in subsequent processes that may allow for a faster and more efficient superimposing process.

The 2D projection may be an instant image of the segmented virtual 3D model of the dental object from the initial position. The 2D projection may thus be a screenshot of the segmented virtual 3D model of the dental object as viewed from the initial position. The 2D projection may thus comprise 2D information, that may be pixels.

The one or more processors may be configured to use the algorithm to take an instant image (e.g. a screenshot) of the segmented virtual 3D model of the dental object from the initial position that was determined by using the third neural network. The algorithm may further be configured to obtain a second group of 2D information that may be the pixels of the screenshot (the instant image).

For example, the one or more processors may forward information about the determined initial position that was obtained using the third neural network to the algorithm. The one or more processors may subsequently use the algorithm to obtain a screenshot (an instant 2D image) of the segmented virtual 3D model of the dental object as viewed from the determined initial position, thereby acquiring a 2D projection (the screenshot) of the segmented virtual 3D model, comprising 2D information that are the pixels of the screenshot (the instant image, the 2D projection).

Alternatively, the 2D projection may be a set of 2D information, which may be a set of 2D data points of the segmented virtual 3D model, onto a projection plane in the determined initial position.

The information about the determined initial position, that was obtained using the third neural network, may be forwarded to the algorithm, using the one or more processors. A projection plane may be arranged in the determined initial position by the algorithm, using the forwarded information. The algorithm may further be configured to extract 2D data points from the segmented virtual 3D model of the dental object, and arrange them on a corresponding position on the projection plane. The algorithm may further be configured to assign a depth value for each arranged 2D data point on the projection plane such, that the projection plane contains 2D data points having 2D coordinates and a depth value.

For example, the one or more processors may forward information about the determined initial position that was obtained using the third neural network to the algorithm. The algorithm may use the forwarded information to arrange a projection plane in the determined initial position. The algorithm may then extract 2D data points from the segmented virtual 3D model of the dental object, and arrange them on a corresponding position in the projection plane. The algorithm may then assign a depth value for each arranged data point on the projection plane.

The method may further comprise a step of aligning the first group of 2D information of the segmented 2D image with the second group of 2D information of the 2D projection of the segmented virtual 3D model.

The method may further comprise a step of determining a first number of coinciding 2D information between the first group of 2D information and the second group of 2D information.

The first group of 2D information may be aligned with the second group of 2D information by the one or more processors using the algorithm. Thus, aligning the first group of 2D information with the second group of 2D information may be performed by the algorithm. The method may perform the aligning of the first group of 2D information with the second group of 2D information by changing a position, an orientation, and/or a size of the first group of 2D information of the segmented 2D image, using the algorithm.

The algorithm may be configured to arrange the first group of 2D information on the second group of 2D information. The algorithm may further be configured to arrange the segmented 2D image on the 2D projection.

Aligning the first group of 2D information with the second group of 2D information, or the segmented 2D image with the 2D projection, may allow for determining which 2D information between the segmented 2D image and the 2D projection coincide with each other.

A first number of coinciding 2D information between the first group of 2D information and the second group of 2D information my be determined by the one or more processors. The one or more processors may be configured to determine the first number of coinciding 2D information using the algorithm. The algorithm may be configured to determine the first number of coinciding 2D information.

Determining a first number of coinciding 2D information between the segmented 2D image and the 2D projection may allow for determining whether the initial position is acceptable for superimposing the segmented 2D image on the virtual 3D model, or a different position of the segmented 2D image relative to the segmented virtual 3D model is needed.

The algorithm may be configured to determine a first number of coinciding 2D information. The first number of coinciding 2D information may be 2D information from the first group of 2D information and the second group of 2D information, that are identical, similar to each other, have the same colour, have the same size, have the same graphic content, have the same position and/or orientation, or are arranged within the same segmented dental object, e.g. are arranged within a contour of the same dental object.

For example, the algorithm may obtain a segmented 2D image of a tooth, wherein a first group of pixels are within a contour of the tooth. The algorithm may further obtain another image, which is a screenshot of a virtual 3D model of the tooth taken from an initial position, wherein a second group of pixels are within a contour of the tooth in the screenshot. The algorithm determines or identifies the pixels that are of the first group of pixels in the segmented 2D image and the pixels that are of the second group of pixels in the screenshot. The algorithm subsequently determines a number of coinciding pixels, by determining the number of pixels from both groups of pixels (the first group of pixels and the second group of pixels) are within the depicted tooth in both images (the segmented 2D image and the screenshot).

The method may use one of several known methods for determining coinciding pixels or objects in different images, such as the “Intersection over Union”-method (IoU), where a degree of overlap between an object in two images is detected, or where a probability for objects in two segmented images intersecting, is determined. The method may use the algorithm to perform the above mentioned methods.

The method may further comprise a step of repeatedly determining another number of coinciding 2D information between the first group of 2D information and the second group of 2D information. The another number of coinciding 2D information may be determined using different positions of the segmented 2D image relative to the segmented virtual 3D model, or vice versa. The step of repeatedly determine the another number of coinciding 2D information may be repeated until the another number of coinciding 2D information reaches a predetermined number of coinciding 2D information.

The step of repeatedly determining the another number of coinciding 2D information may be performed by the one or more processors using the algorithm.

The one or more processors may repeatedly determine the another number of coinciding 2D information and determining the different positions, using the algorithm. The algorithm may be configured to determine the different positions. The algorithm may further be configured to repeatedly determine the another number of coinciding 2D information. The algorithm may be configured to repeatedly determine the another number of coinciding 2D information until the another number of coinciding 2D information reaches the predetermined number of coinciding 2D information.

For example, four different positions, one to the right, one to the left, one above, and one below the initial position, may be determined using the algorithm. For every one of the four different positions, the above described process of determining the another number is repeated, thereby determining four another number of coinciding 2D information. The algorithm may subsequently determine which of the four another numbers of coinciding 2D information is the largest number, and based on the largest number, determine where to arrange a next different position, so that a larger number of coinciding 2D information may be obtained for every repetition.

The predetermined number may be a fixed number, a number that is based on a user input, or a calculated number, such as a ratio. The one or more processors or algorithm is configured to terminate the process of determining another number of coinciding 2D information, when the another number of coinciding 2D information reaches the predetermined number or exceeds the predetermined number. The predetermined number may be a number of pixels, an index, or a ratio.

For a more detailed example, see the description of FIG. 3A-3B below.

The method may further comprise a step of superimposing the segmented 2D image on the segmented virtual 3D model in the position at which the another number of coinciding 2D information has reached the predetermined number of coinciding 2D information. The method may further comprise a step of displaying the superimposed segmented 2D image on the segmented virtual 3D model and diagnostics and/or health data from the 2D image and from the intraoral scan data (virtual 3D model) on a display simultaneously, or vice versa, such that the segmented virtual 3D model may be superimposed on the segmented 2D image.

Displaying the superimposed segmented 2D image on the segmented virtual 3D model with diagnostics and/or health data may allow a dental practitioner to more efficiently and conveniently obtain details about a patients dental condition.

A dentist may for example view a bitewing (x-ray image) showing status of the hard tissues (tooth and bone), the bitewing superimposed on a virtual 3D model of the patients dentition, the virtual 3D model showing status of the soft (gums) and hard tissues in the patients dentition. The dentist may hereby efficiently and conveniently view several diagnostics and health data of the patient simultaneously, without having to switch between a view of the bitewing and a view of the virtual 3D model. The dentist is furthermore not required to acquire a bitewing containing information indicating from which angle the bitewing was taken, but can use any bitewing of the patients dentition.

Furthermore, the virtual 3D model of the dental object may be superimposed on the 2D image of the dental object.

For example, a virtual 3D model of a first-, a second-, and a third molar teeth of a lower jaw of a patient's dentition, may be superimposed on a panoramic x-ray image of the dentition of the same patient, including the same lower jaw and the same first-, second-, and third molar teeth (the situation is illustrated in FIG. 4 of the present disclosure). A dental practitioner viewing a such displayed superimposed virtual 3D model on a panoramic x-ray, may get an overview of diagnostics and/or health information of several dental conditions obtained from the virtual 3D model and the panoramic x-ray, simultaneously, and may thus perform a diagnosis of the patient's dental condition more efficiently. Such information may for example be bone level associated with gum disease (from the panoramic x-ray image), and gingival status (gingival margin level and inflammation) in the patient's dentition (from the virtual 3D model).

Those skilled in the art will recognize still other aspects of the present application upon reading and understanding the attached description.

The handheld intraoral scanner system may be configured to determine a position of a segmented 2D image of a dental object relative to a segmented virtual 3D model of the dental object. The system may comprise a handheld intraoral scanner configured to acquire intraoral scan data of the dental object for generating or updating a virtual 3D model of the dental object, a 2D image of the dental object. The system further comprises one or more processors that is configured to segment the 2D image of the dental object and obtain a first group of 2D information of the segmented 2D image, segment the virtual 3D model of the dental object, determine an initial position of the segmented 2D image relative to the segmented virtual 3D model, obtain a 2D projection of the segmented virtual 3D model onto a projection plane in the determined initial position and obtain a second group of 2D information of the 2D projection of the segmented virtual 3D model, and align the first group of 2D information of the segmented 2D image with the second group of 2D information of the 2D projection of the segmented virtual 3D model until a determined first number of coinciding 2D information between the first group of 2D information and the second group of 2D information has reached a predetermined number of coinciding 2D information.

The alignment of the first group of 2D information with the second group of 2D information may performed based on an image alignment algorithm that is feature based and include one of the following algorithms:
Keypoint detectors (such as DoG, Harri, GFFT etc.)
Local Invariant Descriptors (such as SIFT, SURF, ORB etc.)
Keypoint matching (such as Ransac, and its variants)
Similarity measurements based on cross-correlation or sub of squared intensity differences, and
Deep learning

### BRIEF DESCRIPTION OF THE FIGURES

Aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 illustrates a handheld intraoral scanner system comprising a handheld intraoral scanner, a first-, second-, and third neural network, an algorithm, 2D image of a dental object, a virtual 3D model of the dental object, and the 2D image superimposed on the virtual 3D model;

FIG. 2 illustrates the 2D image segmented and the virtual 3D model segmented;

FIG. 3A schematically illustrates an exemplary process of determining another initial position of the 2D image relative to the virtual 3D model;

FIG. 3B schematically illustrates an exemplary continuation of the process of FIG. 3A and further schematically illustrates the 2D image superimposed on the virtual 3D model;

FIG. 4 is a screenshot of a graphical user interface of a software, showing a superimposed virtual 3D model on an x-ray image including health information; and

FIG. 5 shows a table with an overview of a method for the handheld intraoral scanner system comprising steps for superimposing a 2D image of a dental object on a virtual 3D model of the dental object.

### DETAILED DESCRIPTION

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the devices, systems, mediums, programs and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include microprocessors, microcontrollers, digital signal processors (DSPs), field programmable gate arrays (FPGAs), programmable logic devices (PLDs), gated logic, discrete hardware circuits, and other suitable hardware configured to perform the various functionality described throughout this disclosure. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

A scanning for providing extra-oral scan data and/or intra-oral scan data may be performed by a dental scanning system that may include an intraoral scanning device such as the TRIOS series scanners from 3Shape A/S or a laboratory-based scanner such as the E-series scanners from 3Shape A/S. The dental scanning system may include a wireless capability as provided by a wireless interface such as a wireless network unit. The scanning device may employ a scanning principle such as triangulation-based scanning, confocal scanning, focus scanning, ultrasound scanning, x-ray scanning, stereo vision, structure from motion, optical coherent tomography OCT, or any other scanning principle. In an embodiment, the scanning device is capable of obtaining surface information by operated by projecting a pattern and translating a focus plane along an optical axis of the scanning device and capturing a plurality of 2D images at different focus plane positions such that each series of captured 2D images corresponding to each focus plane forms a stack of 2D images. The acquired 2D images are also referred to herein as raw 2D images, wherein raw in this context means that the images have not been subject to image processing. The focus plane position is preferably shifted along the optical axis of the scanning system, such that 2D images captured at a number of focus plane positions along the optical axis form said stack of 2D images (also referred to herein as a sub-scan) for a given view of the object, i.e., for a given arrangement of the scanning system relative to the object. After moving the scanning device relative to the object or imaging the object at a different view, a new stack of 2D images for that view may be captured. The focus plane position may be varied by means of at least one focus element, e.g., a moving focus lens. The scanning device is generally moved and angled relative to the dentition during a scanning session, such that at least some sets of sub-scans overlap at least partially, in order to enable reconstruction of the digital dental 3D model by stitching overlapping subscans together in real-time and display the progress of the virtual 3D model on a display as feedback to the user. The result of stitching is the digital 3D representation of a surface larger than that which can be captured by a single sub-scan, i.e., which is larger than the field of view of the 3D scanning device. Stitching, also known as registration and fusion, works by identifying overlapping regions of 3D surface in various sub-scans and transforming sub-scans to a common coordinate system such that the overlapping regions match, finally yielding the digital 3D model. An Iterative Closest Point (ICP) algorithm may be used for this purpose. Another example of a scanning device is a triangulation scanner, where a time varying pattern is projected onto the dental object and a sequence of images of the different pattern configurations are acquired by one or more cameras located at an angle relative to the projector unit.

Colour texture of the dental object may be acquired by illuminating the object using different monochromatic colours such as individual red, green and blue colours or my illuminating the object using multichromatic light such as white light. A 2D image may be acquired during a flash of white light.

Generally, the process of obtaining surface information in real time of a dental object to be scanned requires the scanning device to illuminate the surface and acquire high number of 2D images. Typically, a high-speed camera is used with a framerate of 300-2000 2D frames pr second dependent on the technology and 2D image resolution. The high amount of image data needed to be handled by the scanning device to either directly forward the raw image data stream to an external processing device or performing some image processing before transmitting the data to an external device or display. This process requires that multiple electronic components inside the scanner is operating with a high workload thus requiring a high demand of current.

The scanning device comprises one or more light projectors configured to generate an illumination pattern to be projected on a three-dimensional dental object during a scanning session. The light projector(s) preferably comprises a light source, a mask having a spatial pattern, and one or more lenses such as collimation lenses or projection lenses. The light source may be configured to generate light of a single wavelength or a combination of wavelengths (mono-or polychromatic). The combination of wavelengths may be produced by using a light source configured to produce light (such as white light) comprising different wavelengths. Alternatively, the light projector(s) may comprise multiple light sources such as LEDs individually producing light of different wavelengths (such as red, green, and blue) that may be combined to form light comprising the different wavelengths. Thus, the light produced by the light source may be defined by a wavelength defining a specific colour, or a range of different wavelengths defining a combination of colours such as white light. In an embodiment, the scanning device comprises a light source configured for exciting fluorescent material of the teeth to obtain fluorescence data from the dental object. Such a light source may be configured to produce a narrow range of wavelengths. In another embodiment, the light from the light source is infrared (IR) light, which is capable of penetrating dental tissue. The light projector(s) may be DLP projectors using a micro mirror array for generating a time varying pattern, or a diffractive optical element (DOF), or back-lit mask projectors, wherein the light source is placed behind a mask having a spatial pattern, whereby the light projected on the surface of the dental object is patterned. The back-lit mask projector may comprise a collimation lens for collimating the light from the light source, said collimation lens being placed between the light source and the mask. The mask may have a checkerboard pattern, such that the generated illumination pattern is a checkerboard pattern. Alternatively, the mask may feature other patterns such as lines or dots, etc.

The scanning device preferably further comprises optical components for directing the light from the light source to the surface of the dental object. The specific arrangement of the optical components depends on whether the scanning device is a focus scanning apparatus, a scanning device using triangulation, or any other type of scanning device. A focus scanning apparatus is further described in EP 2 442 720 B1 by the same applicant, which is incorporated herein in its entirety.

The light reflected from the dental object in response to the illumination of the dental object is directed, using optical components of the scanning device, towards the image sensor(s). The image sensor(s) are configured to generate a plurality of images based on the incoming light received from the illuminated dental object. The image sensor may be a high-speed image sensor such as an image sensor configured for acquiring images with exposures of less than 1/1000 second or frame rates in excess of 250 frames pr. Second (fps). As an example, the image sensor may be a rolling shutter (CCD) or global shutter sensor (CMOS). The image sensor(s) may be a monochrome sensor including a colour filter array such as a Bayer filter and/or additional filters that may be configured to substantially remove one or more colour components from the reflected light and retain only the other non-removed components prior to conversion of the reflected light into an electrical signal. For example, such additional filters may be used to remove a certain part of a white light spectrum, such as a blue component, and retain only red and green components from a signal generated in response to exciting fluorescent material of the teeth.

The wireless network unit is configured to wirelessly connect the intraoral scanning system to a network comprising a plurality of network elements including at least one network element configured to receive the processed data.

The dental scanning system preferably further comprises a processor configured to generate scan data (such as extra-oral scan data and/or intra-oral scan data) by processing the two-dimensional (2D) images acquired by the scanning device. The processor may be part of the scanning device. As an example, the processor may comprise a Field-programmable gate array (FPGA) and/or an Advanced RISC Machines (ARM) and/or a x86 processor and/or a combination of FPGA, ARM, and/or x86 processors located on the scanning device. The scan data comprises information relating to the three-dimensional dental object. The scan data may comprise any of: 2D images, 3D point clouds, depth data, texture data, intensity data, colour data, and/or combinations thereof. As an example, the scan data may comprise one or more-point clouds, wherein each point cloud comprises a set of 3D points describing the three-dimensional dental object. As another example, the scan data may comprise images, each image comprising image data e.g., described by image coordinates and a timestamp (x, y, t), wherein depth information can be inferred from the timestamp. The image sensor(s) of the scanning device may acquire a plurality of raw 2D images of the dental object in response to illuminating said object using the one or more light projectors. The plurality of raw 2D images may also be referred to herein as a stack of 2D images. The 2D images may subsequently be provided as input to the processor, which processes the 2D images to generate scan data. The processing of the 2D images may comprise the step of determining which part of each of the 2D images are in focus in order to deduce/generate depth information from the images. The depth information may be used to generate 3D point clouds comprising a set of 3D points in space, e.g., described by cartesian coordinates (x, y, z). The 3D point clouds may be generated by the processor or by another processing unit. Each 2D/3D point may furthermore comprise a timestamp that indicates when the 2D/3D point was recorded, i.e., from which image in the stack of 2D images the point originates. The timestamp is correlated with the z-coordinate of the 3D points, i.e., the z-coordinate may be inferred from the timestamp. Accordingly, the output of the processor is the scan data, and the scan data may comprise image data and/or depth data, e.g., described by image coordinates and a timestamp (x, y, t) or alternatively described as (x, y, z). The scanning device may be configured to transmit other types of data in addition to the scan data. Examples of data include 3D information, texture information such as infra-red (IR) images, fluorescence images, reflectance colour images, x-ray images, and/or combinations thereof.

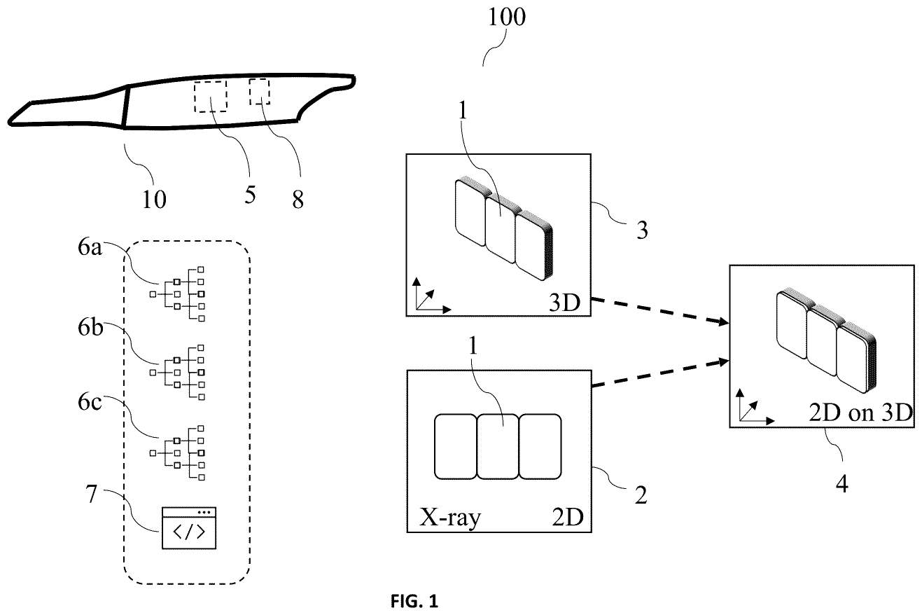

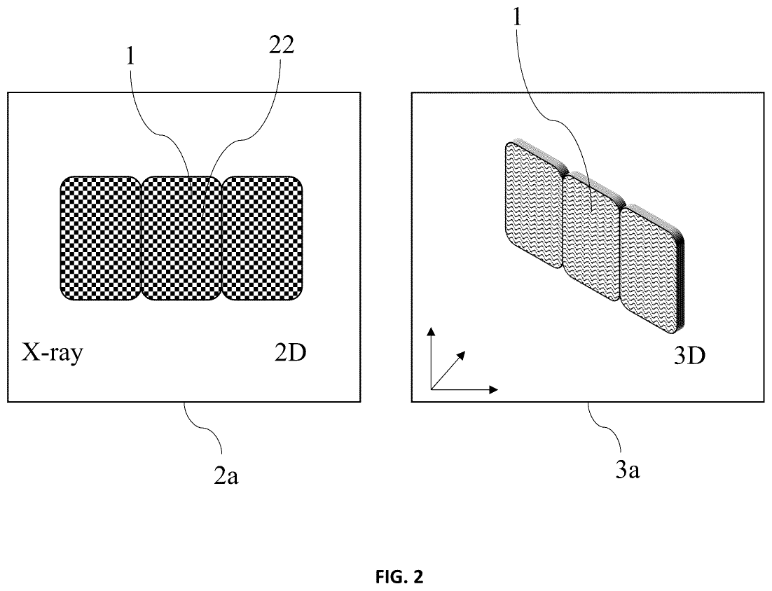

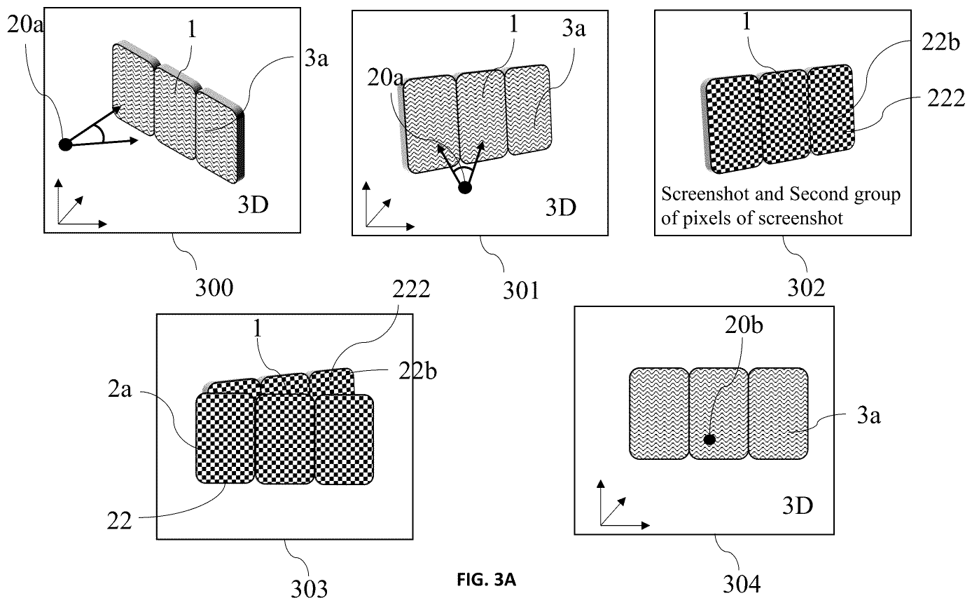

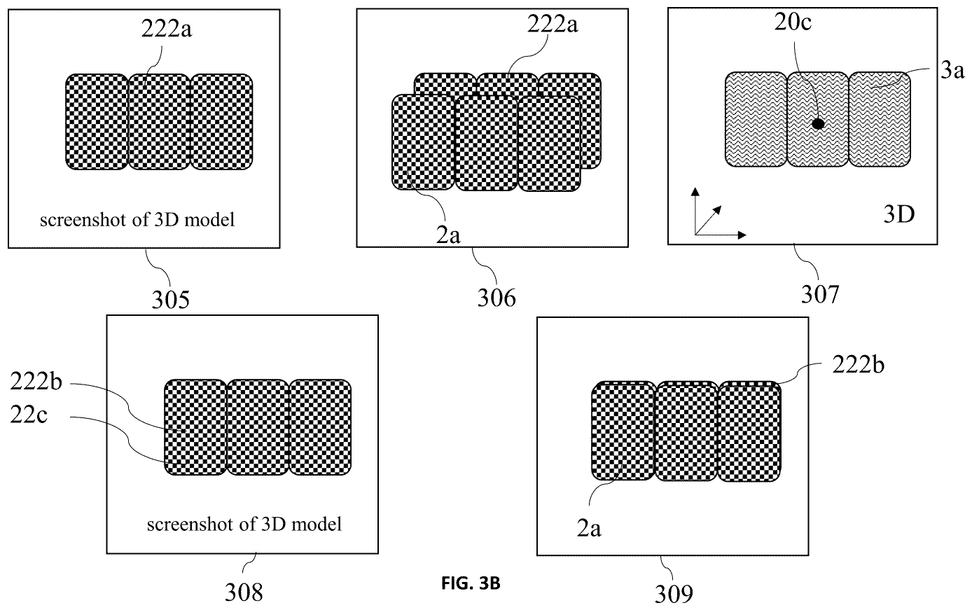

FIG. 1 illustrates a handheld intraoral scanner system 100 comprising a handheld intraoral scanner 10 that comprises one or more processors 5, a 2D image 2 of teeth 1 shown as an x-ray, a virtual 3D model 3 of the teeth 1, an image 4 of the 2D image 2 superimposed on the virtual 3D model 3, a first neural network 6a that is trained to segment a dental object 1 in a 2D image 2, a second neural network 6b that is trained to segment a dental object 1 in a virtual 3D model 3, and a third neural network 6c that is trained to determine an initial position 20a (FIGS. 3A-3B) of a segmented 2D image 2a (FIG. 2) of a dental object 1 relative to any corresponding dental object 1 of a segmented virtual 3D model 3a (FIG. 2), and an algorithm 7 that is configured to superimpose the segmented 2D image 2a on the segmented virtual 3D model 3a of the dental object 1. The algorithm 7 and the first-, second-, and third neural networks 6a-6c, may be located fully or partly in the handheld intraoral scanner 10, partly or fully located in a computer, or partly or fully located in a server, such as in a cloud-system. The one or more processors 5 are configured to execute and use the first-, second-, and third neural networks 6a-6c and the algorithm 7.

FIG. 2 shows the 2D image 2 after being segmented by the first neural network 6a and the virtual 3D model 3 after being segmented by the second neural network 6b. The segmented 2D image 2a is shown depicting a dental object 1, shown as three teeth 1, and the pixels constituting the dental object 1, are represented by the checkerboard pattern on the three teeth 1, and referred to as a first group of pixels 22. The first group of pixels 22 may be determined by the algorithm 7. Since the 2D image 2a is segmented, the first group of pixels 22 constituting the dental object 1 and the contour of the dental object 1, are defined and separable from the rest of the segmented 2D image 2a. The segmented virtual 3D model 3a of the dental object 1, shown as three teeth 1, in FIG. 2, is further shown segmented using triangulation. The segmentation is shown represented by waves on the dental object 1.

FIGS. 3A-3B shows a series of illustrations 300-309 illustrating the process of obtaining an optimal position for superimposing the segmented 2D image 2a on the segmented virtual 3D model 3a.

Illustration 300 shows an initial position 20a relative to the segmented virtual 3D model 3a. The initial position 20a is determined by the third neural network 6c, that is trained to determine an initial position 20a of a segmented 2D image 2a of a dental object 1 relative to a corresponding dental object 1 of a segmented virtual 3D model 3a. The third neural network 6c, based on the data that it has been trained on, did recognize the three teeth 1 shown in the segmented 2D image 2a, and determined an approximate initial position 20a in space (three dimensions) relative to the segmented virtual 3D model 3a that is in the immediate vicinity of the corresponding teeth 1 in the segmented virtual 3D model 3a. Illustration 301 illustrates a view on the segmented virtual 3D model 3a from the determined initial position 20a. Illustration 302 illustrates the subsequent process, which is obtaining screenshot 222 of the segmented virtual 3D model 3a as viewed from the determined initial position 20a. The illustration 302 further shows a second group of pixels 22a, represented as a checkerboard pattern on the three teeth shown on the screenshot 222. The second group of pixels 222 may be determined by the algorithm 7. The subsequent process is illustrated in illustration 303, where the segmented 2D image 2a is aligned with the screenshot 222. In this process, the algorithm 7 arranges the segmented 2D image 2a on the screenshot 222, and determines a number of coinciding pixels 30. If the determined number of coinciding pixels 30 is less than a predetermined number of coinciding pixels, a different position 20b (illustration 304) is determined using the algorithm 7, and the process of obtaining a screenshot 222 from that different position 20b, aligning the segmented 2D image 2a on the screenshot 222, and determining a number of coinciding pixels 30, is repeated, as illustrated in the subsequent illustrations 304-309.

The number of coinciding pixels 30 is a measurement of an acceptable fit, and represents a criteria for superimposing the segmented 2D image 2a on the segmented virtual 3D model 3a from the position, at which the most recent number of coinciding pixels was determined.

The different position 20b is determined by the algorithm 7, wherein the algorithm 7 may determine a number of coinciding pixels 30 in space at a position to the right, to the left, above, below in front of, and behind the initial position 20a, and based on the highest determined number of coinciding pixels 30, determines the different position 20b. For example, if the number of coinciding pixels 30 on the right side is larger than the one on the left side, it indicates that a better alignment is achieved when arranging the different position 20b to the right relative to the initial position 20a.

Illustration 304 illustrates a subsequent process, where the different position 20b, in three dimensional space, relative to the segmented virtual 3D model 3a has been determined. The illustration shows that the different position 20b has been determined to be located to the right and above the initial position 20a shown in illustration 300, and further shown oriented perpendicular to the segmented virtual 3D model 3a. The subsequent illustration 305 illustrates a another screenshot 222a taken from the different position 20b. The illustration further shows pixels of the screenshot represented by a checkerboard pattern. Illustration 306 shows a process where the algorithm 7 aligns the segmented 2D image 2a on the another screenshot 222a of illustration 305 from the different position 20b of illustration 304. The previously described process of determining a number of coinciding pixels 30 is subsequently repeated, and another number of coinciding pixels 30a is determined for the process shown in illustration 306.

The algorithm 7 subsequently determines a new different position 20c in space relative to the segmented virtual 3D model 3a based on the another number of coinciding pixels 30a, as previously described, and as shown in illustration 307. The algorithm 7 subsequently obtains yet another screenshot 222b of the segmented virtual 3D model 3a from the new different position 20c, and a new second group of pixels 22c is determined, as shown represented by a checkerboard pattern in illustration 308. The algorithm 7 subsequently aligns the segmented 2D image 2a on the yet another screenshot 222b by aligning the first group of pixels 22 with the new second group of pixels 22c at the new different position 20c as shown in illustration 309. The algorithm 7 subsequently determines a new another number of coinciding pixels 30b. The process of determining a number of coinciding pixels is ended, when a final number of coinciding pixels reaches a predetermined number of coinciding pixels, and the segmented 2D image 2a is superimposed on the segmented virtual 3D model 3a from a final different position which was used to determine the most recent number of coinciding pixels, and which reached the predetermined number of coinciding pixels.

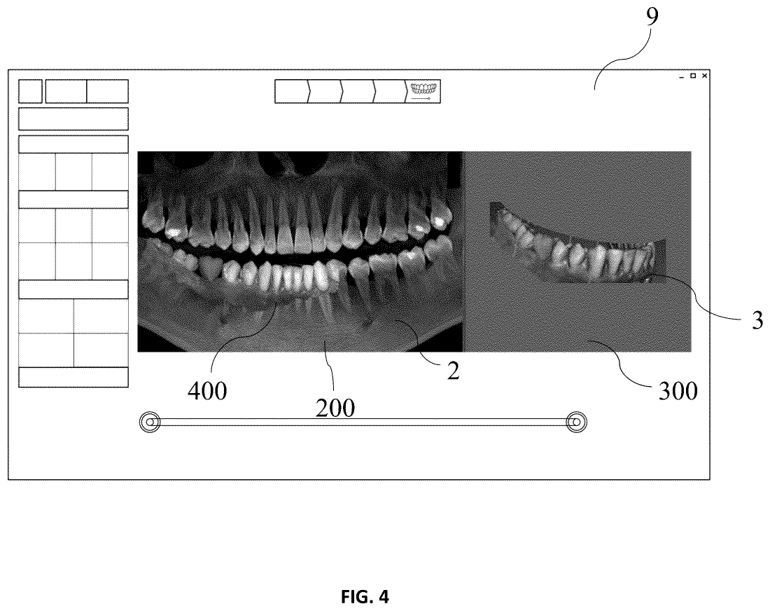

FIG. 4 shows an image of a graphical user interface 9 of a software, configured to display a virtual 3D model 3 of a dental object 1, a 2D image 2 of the dental object 1, and an image 400 of the virtual 3D model 3 superimposed on the 2D image 2, or vice versa. In the present example shown in FIG. 4, a part of the virtual 3D model 3 is shown superimposed 400 on the 2D image 2 (shown in the left-hand side window 200). The graphical user interface 9 is shown having two windows 200, 300, a right-hand side window 300 and a left-hand side window 200. The right-hand side window 300 shows a virtual 3D model 3 of a lower jaw of a dentition including teeth and surrounding gingiva. The left-hand side window 200 shows a panoramic x-ray image 2 of the same dentition, including the lower jaw, the teeth, and the surrounding gingiva. The left-hand side window 200 further shows the virtual 3D model 3 from the right-hand side window 300 superimposed 400 on the corresponding (same) teeth in the panoramic x-ray image 200. The image 400 in the left-hand side window further shows diagnostics and health information in the form of bone level, provided by the panoramic x-ray image 2, 400, and gingival status (gingival margin level, inflammation), provided by the superimposed virtual 3D model 3, 400. In an example, the dental practitioner may have performed an intraoral scan of a patient's teeth using a handheld intraoral scanner 10, thereby acquiring the virtual 3D model 3 of the patient's dentition. The virtual 3D model 3 is displayed in a graphical user interface 9 on a display. The dentist then selects an area of interest on the virtual 3D model 3 of the dentition, such as the lower jaw, as shown in the right-hand side window 300. The dentist then selects a previously captured 2D image 2 of the same dentition including the lower jaw, such as the panoramic x-ray image 2 shown in the left-hand side window 200. The dentist then initiates a superimpositioning 400 of the virtual 3D model 3 of the lower jaw onto the panoramic x-ray image 2, for example by clicking on a button in the graphical user interface 9 on the display. The one or more processors 5 then performs the superimpositioning 400 using the first-, second-, and third neural networks 6a-6c and the algorithm 7, as previously described in this disclosure. The resulting superimpositioning 400 of the virtual 3D model 3 of the lower jaw onto the corresponding lower jaw in the panoramic x-ray image 2 is then displayed in the graphical user interface 9 on the display, as shown in the left-hand side window 200, 400 of FIG. 4.

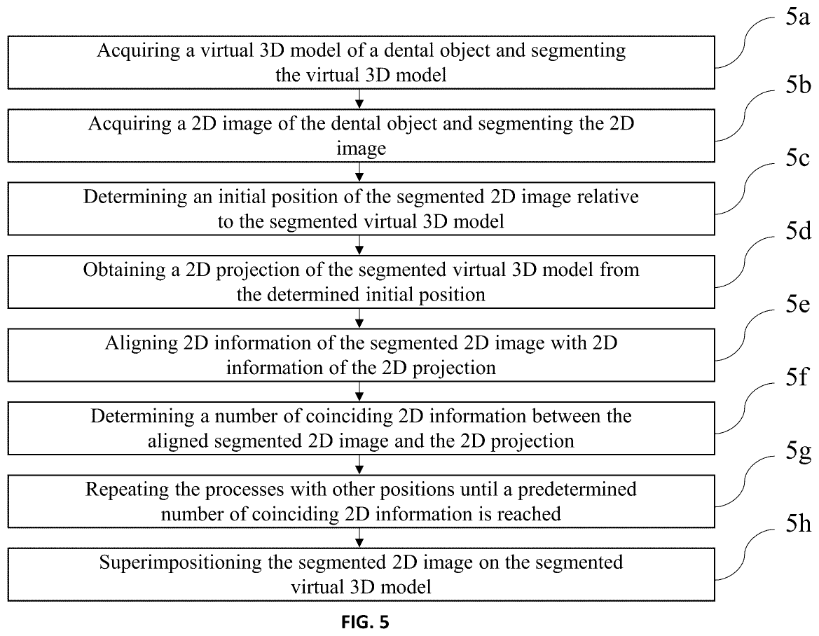

FIG. 5 shows a table with an overview of a method for the handheld intraoral scanner system comprising steps for superimposing a 2D image 2 of a dental object 1 on a virtual 3D model 3 of the dental object 1.

In step 5a, a virtual 3D model 3 of a dental object 1 is acquired and segmented. In an example, the virtual 3D model 3 may be acquired by a handheld intraoral scanner 10, by scanning a physical 3D model of a dental impression, or by loading a previously scanned virtual 3D model 3 into a memory unit 4 of the handheld intraoral scanner system 100, such as into the memory of a computer.

When the virtual 3D model 3 of the dental object 1 is acquired, the virtual 3D model 3 is segmented. The segmentation may be performed using the second neural network 6b that has been trained to segment any virtual 3D model of dental objects, as previously described in this disclosure.

In step 5b, a 2D image 2 of a dental object 1 is acquired and segmented. The 2D image 2 may be acquired by a handheld intraoral scanner 10 or camera, and may thus for example be a colour image or an infrared image. In another example, the 2D image 2 may be acquired by extraoral means such as an x-ray generator or ultrasound scanner, and may thus be an x-ray, panoramic x-ray, a bitewing, or an ultrasound image. In yet another example, the 2D image 2 may be acquired by loading the 2D image into a memory unit 4 of the handheld intraoral scanner system 100, such as into the memory of a computer. When the 2D image 2 of the dental object 1 is acquired, the 2D image 2 is segmented. The segmentation may be performed using the first neural network 6a that has been trained to segment any 2D images of dental objects, as previously described in this disclosure. An algorithm 7 may obtain a first group of pixels 22 of the dental object in the segmented 2D image 2a.

In step 5c, an initial position 20a of the segmented 2D image 2a relative to the segmented virtual 3D model 3a is determined. The one or more processors 5 may determine the initial position 20a by using a third neural network 6c that is trained to determine a position of a segmented 2D image of a dental object relative to a corresponding dental object of a segmented virtual 3D model.

In step 5d, the algorithm 7 obtains a 2D projection 222 of the segmented virtual 3D model 3a from the determined initial position 20a. The algorithm 7 may obtain a second group of 2D information 22b. The second group of 2D information 22b may be 2D data points 22b comprising 2D coordinates of the segmented virtual 3D model 3a onto a plane that is arranged in the determined initial position 20a. Alternatively, the second group of 2D information 22b may be a second group of pixels 22b. The second group of pixels may be obtained by obtaining a screenshot 222 of the segmented virtual 3D model 3a from the determined initial position 20a.

In step 5e, the segmented 2D image 2a is aligned with the 2D projection 222. The one or more processors 5 may use the algorithm 7 to perform the alignment. The algorithm 7 may align 2D information 22 of the segmented 2D image 2a, that may be a first group of pixels 22, with 2D information 22b of the 2D projection 222, which may be a second group of pixels 22b.

In step 5f, the one or more processors 5 may use the algorithm 7 to determine a number of coinciding 2D information 30 between the segmented 2D image 2a and the 2D projection 222. The algorithm 7 may use the “Intersection over Union” method to determine the number of coinciding pixels 30 between the first group of pixels 22 and the second group of pixels 22b.

In step 5g, the one or more processors 5 repeat steps 5d-5f using different positions 20b, until the number of coinciding 2D information 30 reaches a predetermined number of coinciding 2D information. The algorithm 7 may determine numbers of coinciding pixels from different positions around the determined initial position, and based on the different position for which the largest number of coinciding pixels is achieved, determines the different position for use in step 5g when repeating steps 5d-5f, using the different position.

In step 5h, the one or more processors 5 may use the algorithm 7 to superimpose the segmented 2D image 2a on the segmented virtual 3D model 3a from the determined position, that was used when the number of coinciding pixels reached the predetermined number of coinciding pixels.

Although some embodiments have been described and shown in detail, the disclosure is not restricted to such details, but may also be embodied in other ways within the scope of the subject matter defined in the following claims. In particular, it is to be understood that other embodiments may be utilized, and structural and functional modifications may be made without departing from the scope of the present invention.

Benefits, other advantages, and solutions to problems have been described herein with regard to specific embodiments. However, the benefits, advantages, solutions to problems, and any component(s)/unit(s) that may cause any benefit, advantage, or solution to occur or become more pronounced are not to be construed as critical, required, or essential features or components/elements of any or all the claims or the invention. The scope of the invention is accordingly to be limited by nothing other than the appended claims, in which reference to a component/unit/element in the singular is not intended to mean “one and only one” unless explicitly so stated, but rather “one or more.” A claim may refer to any of the preceding claims, and “any” is understood to mean “any one or more” of the preceding claims.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e., to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The step of any disclosed method is not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects.

The claims are not intended to be limited to the aspects shown herein but is to be accorded the full scope consistent with the language of the claims, wherein reference to an element in the singular is not intended to mean “one and only one” unless specifically so stated, but rather “one or more.” Unless specifically stated otherwise, the term “some” refers to one or more.

### Items

1. A handheld intraoral scanner system (100) configured to determine a position of a segmented 2D image (2a) of a dental object (1) relative to a segmented virtual 3D model (3a) of the dental object (1), wherein the system (100) comprises:
   a handheld intraoral scanner (10) configured to acquire intraoral scan data of the dental object (1) for generating or updating a virtual 3D model (3) of the dental object (1),
   a 2D image (2) of the dental object (1), and
   one or more processors (5) that is configured to:
      segment the 2D image (2) of the dental object (1) and obtain a first group (22) of 2D information of the segmented 2D image (2a),
      segment the virtual 3D model (3) of the dental object (1),
      determine an initial position (20a) of the segmented 2D image (2a) relative to the segmented virtual 3D model (3a),
      obtain a 2D projection (222) of the segmented virtual 3D model (3a) onto a projection plane in the determined initial position (20a) and obtain a second group (22b) of 2D information of the 2D projection (222) of the segmented virtual 3D model (3a), and
      align the first group (22) of 2D information of the segmented 2D image (2a) with the second group (22b) of 2D information of the 2D projection (222) of the segmented virtual 3D model (3a) until a determined first number of coinciding 2D information (30) between the first group (22) of 2D information and the second group (22b) of 2D information has reached a predetermined number of coinciding 2D information.

1. A handheld intraoral scanner system configured to determine a position of a segmented 2D image of a dental object relative to a segmented virtual 3D model of the dental object wherein the system comprises:
a handheld intraoral scanner configured to acquire intraoral scan data of the dental object for generating or updating a virtual 3D model of the dental object,
a 2D image of the dental object, and
one or more processors that is configured to:
segment the 2D image of the dental object and obtain a first group of 2D information of the segmented 2D image,
segment the virtual 3D model of the dental object,
determine an initial position of the segmented 2D image relative to the segmented virtual 3D model,
obtain a 2D projection of the segmented virtual 3D model onto a projection plane in the determined initial position and obtain a second group of 2D information of the 2D projection of the segmented virtual 3D model,
align the first group of 2D information of the segmented 2D image with the second group of 2D information of the 2D projection of the segmented virtual 3D model and determine a first number of coinciding 2D information between the first group of 2D information and the second group of 2D information, and
repeatedly determine another number of coinciding 2D information between the first group of 2D information and the second group of 2D information using different positions of the segmented 2D image relative to the segmented virtual 3D model until the another number of coinciding 2D information reaches a predetermined number of coinciding 2D information.

2. The system according to claim 1, wherein the one or more processors is further configured to superimpose the segmented 2D image on the segmented virtual 3D model in a position at which the another number of coinciding 2D information has reached the predetermined number of coinciding 2D information.

3. The system according to claim 2, further comprising a display, and the system further configured to displaying the superimposed segmented 2D image on the segmented virtual 3D model on the display and further configured to displaying diagnostics and/or health data from the 2D image and from the intraoral scan data on the display simultaneously.

4. The system according to claim 1, wherein the system further comprises:
a first neural network that is trained to segment any dental objects of 2D images,
a second neural network that is trained to segment any dental objects of virtual 3D models, and
a third neural network that is trained to determine an initial position of a segmented 2D image of a dental object relative to any corresponding dental object of a segmented virtual 3D model,
and wherein:
the 2D image is segmented by the first neural network,
the virtual 3D model is segmented by the second neural network, and
the initial position of the segmented 2D image relative to the segmented virtual 3D model is determined by the third neural network.

5. The system according to claim 1, wherein the system further comprises an algorithm that is configured to:
obtain the 2D projection and the second group of 2D information,
align the first group of 2D information with the second group of 2D information and determine the first number of coinciding 2D information, and
repeatedly determine the another number of coinciding 2D information between the first group of 2D information and the second group of 2D information using the different positions of the segmented 2D image relative to the segmented virtual 3D model, until the another number of coinciding 2D information reaches the predetermined number of coinciding 2D information.

6. The system according to claim 5, wherein the algorithm is further configured to align the first group of 2D information with the second group of 2D information by changing a position, an orientation, and/or a size of 2D information of the 2D image.

7. The system according to claim 1, wherein the one or more processors is configured to obtain a 2D projection of the segmented virtual 3D model onto a projection plan by acquiring another 2D image of the segmented virtual 3D model from the determined initial position.

8. The system according to claim 1, wherein the 2D information are pixels.

9. The system according to claim 1, wherein the 2D image is one of a x-ray image, an infra-red image, a near-infra-red image, or an ultrasound image.

10. The system according to claim 1, wherein the dental object is a tooth, a part of a tooth, or teeth.

11. A method for determining a position of a segmented 2D image of a dental object relative to a segmented virtual 3D model of the dental object, the method comprising the steps of:
acquiring a virtual 3D model of the dental object based on intraoral scan data of the dental object,
acquiring a 2D image of the dental object,
segmenting the 2D image of the dental object and obtaining a first group of 2D information of the segmented 2D image,
segmenting the virtual 3D model of the dental object,
determining an initial position of the segmented 2D image relative to the segmented virtual 3D model,
obtaining a 2D projection of the segmented virtual 3D model onto a projection plane in the determined initial position and obtaining a second group of 2D information of the 2D projection of the segmented virtual 3D model,
aligning the first group of 2D information of the segmented 2D image with the second group of 2D information of the 2D projection of the segmented virtual 3D model and determining a first number of coinciding 2D information between the first group of 2D information and the second group of 2D information, and
repeatedly determining another number of coinciding 2D information between the first group of 2D information and the second group of 2D information using different positions of the segmented 2D image relative to the segmented virtual 3D model, until the another number of coinciding 2D information reaches a predetermined number of coinciding 2D information.

12. The method according to claim 11, further comprising the step of:
superimposing the segmented 2D image on the segmented virtual 3D model in a position at which the another number of coinciding 2D information has reached the predetermined number of coinciding 2D information.

13. The method according to claim 11, wherein:
the 2D image of the dental object is segmented using a first neural network that is trained to segment any dental objects of 2D images,
the virtual 3D model of the dental object is segmented using a second neural network that is trained to segment any dental objects of virtual 3D models, and
the initial position of the segmented 2D image relative to the segmented virtual 3D model is determined using a third neural network that is trained to determine an initial position of a segmented 2D image of a dental object relative to any corresponding dental object of a segmented virtual 3D model.

14. The method according to claim 11, wherein the step of obtaining a 2D projection of the segmented virtual 3D model onto a projection plan is performed by acquiring another 2D image of the segmented virtual 3D model from the determined initial position and wherein the 2D information are pixels.

15. The method according to claim 11, wherein the 2D image is one of a x-ray image, an infra-red image, a near-infra-red image, or an ultrasound image.
